(19) United States
(12) Patent Application Publication
(10) Pub. No.: US 2025/0353294 A1
(43) Pub. Date: Nov. 20, 2025

(54) IMAGE FORMING APPARATUS

(71) Applicant: KYOCERA Document Solutions Inc., Osaka (JP)

(72) Inventors: Naoko Kawashima, Osaka (JP); Hiroomi Nakatsuji, Osaka (JP); Jun Nakano, Osaka (JP); Masato Usui, Osaka (JP)

(21) Appl. No.: 19/205,585

(22) Filed: May 12, 2025

(30) Foreign Application Priority Data
May 16, 2024 (JP) 2024-080091

(51) Int. Cl. B41J 2/045; B41J 2/21

(52) U.S. Cl. CPC B41J 2/0457; B41J 2/04508; B41J 2/04558; B41J 2/2132; B41J 2/04581

(57) ABSTRACT

In an image forming apparatus, a recording element group is configured to eject ink correspondingly to a driving voltage, and a density adjusting unit is configured to (a) cause to eject ink for a first test chart with a first driving voltage and causes to eject ink for a second test chart with a second driving voltage that is different from the first driving voltage, (b) acquire a density of the first test chart and a density of the second test chart, (c) derive a difference between the density of the first test chart and the density of the second test chart, and (d) derive a driving voltage corresponding to a target density on the basis of the difference between the density of the first test chart and the density of the second test chart and a difference between the first driving voltage and the second driving voltage.

### CROSS-REFERENCE TO RELATED APPLICATIONS

This application relates to and claims priority rights from Japanese Patent Application No. 2024-080091, filed on May 16, 2024, the entire disclosures of which are hereby incorporated by reference herein.

### BACKGROUND

### 1. Field of the Present Disclosure

The present disclosure relates to an image forming apparatus.

### 2. Description of the Related Art

An inkjet recording apparatus determines in the first correction a correction value of a driving voltage of a recording head correspondingly to printing densities (image-scanned values) of a test chart on the basis of a predetermined characteristic curve, and in the second correction, determines a density correction value of image data.

In the aforementioned inkjet recording apparatus, a shape of the aforementioned predetermined characteristic curve is constant, and therefore, a type of a print sheet or the like causes fluctuation of a density changing amount corresponding to the correction value of the driving voltage, and consequently, a driving voltage that properly corrects a density may not be acquired.

### SUMMARY

An image forming apparatus according to an aspect of the present disclosure includes a recording element group and a is density adjusting unit. The recording element group configured to eject ink correspondingly to a driving voltage. The density adjusting unit is configured to (a) cause to eject ink for a first test chart with a first driving voltage and causes to eject ink for a second test chart with a second driving voltage that is different from the first driving voltage, (b) acquire a density of the first test chart and a density of the second test chart, (c) derive a difference between the density of the first test chart and the density of the second test chart, and (d) derive a driving voltage corresponding to a target density on the basis of the difference between the density of the first test chart and the density of the second test chart and a difference between the first driving voltage and the second driving voltage.

These and other objects, features and advantages of the present disclosure will become more apparent upon reading of the following detailed description along with the accompanied drawings.

### BRIEF DESCRIPTION OF THE DRAWINGS

FIG. 1 shows a side view that indicates an internal mechanical configuration of an image forming apparatus in an embodiment according to the present disclosure;

FIG. 2 shows a plane view of an example of recording heads 1a to 1d in the image forming apparatus 10 shown in FIG. 1;

FIG. 3 shows a block diagram that indicates an electronic configuration of the image forming apparatus 10 in the embodiment according to the present disclosure;

FIG. 4 shows a diagram that indicates an example of a test chart;

FIG. 5 shows a diagram that explains a relationship between a changing amount of a driving voltage and a changing amount of a density;

FIG. 6 shows a diagram that explains restrainment of density unevenness by plural recording element groups; and

FIG. 7 shows a flowchart that explains a behavior of the image forming apparatus shown in FIGS. 1 to 3.

### DETAILED DESCRIPTION

Hereinafter, an embodiment according to an aspect of the disclosure will be explained with reference to present drawings.

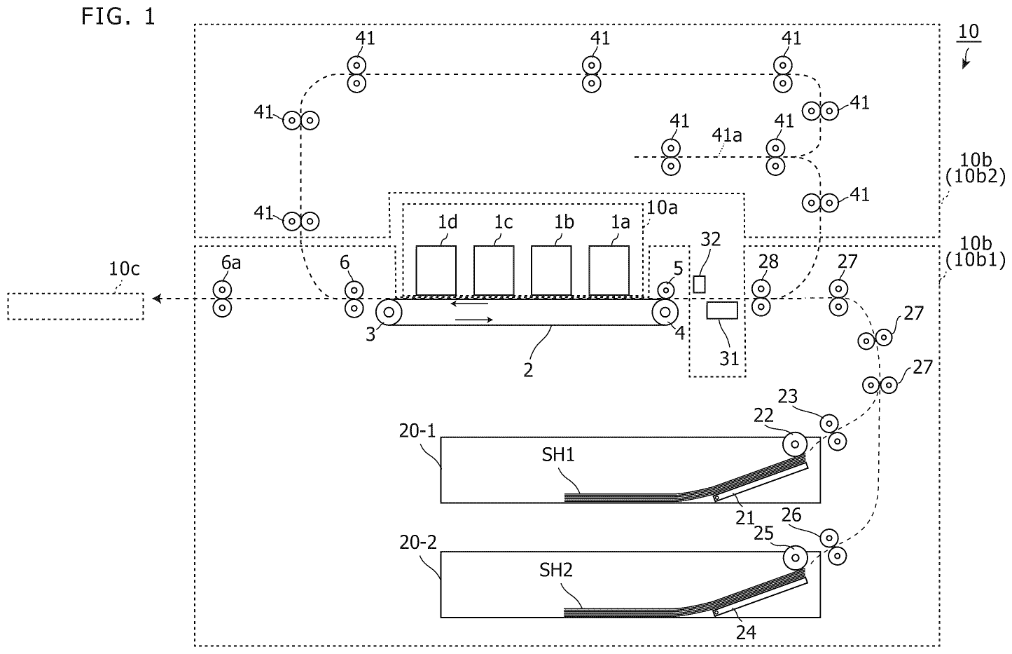

FIG. 1 shows a side view that indicates an internal mechanical configuration of an image forming apparatus in an embodiment according to the present disclosure. The image forming apparatus 10 in this embodiment is an apparatus such as printer, copier, facsimile machine or multi function peripheral.

The image forming apparatus 10 shown in FIG. 1 includes a print engine 10a and a sheet transportation unit 10b. The print engine 10a physically forms an image to be printed on a print sheet (print paper sheet or the like). In this embodiment, the print engine 10a is a line-type inkjet print engine.

In this embodiment, the print engine 10a includes line-type recording heads 1a to 1d corresponding to four ink colors: Cyan, Magenta, Yellow, and Black.

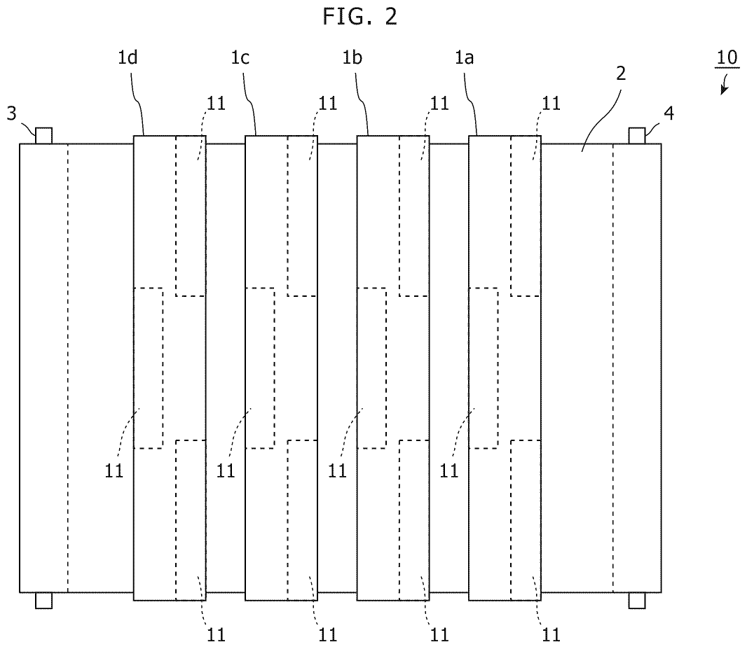

FIG. 2 shows a plane view of an example of recording heads 1a to 1d in the image forming apparatus 10 shown in FIG. 1. As shown in FIG. 2, for example, in this embodiment, each of the inkjet recording units 1a, 1b, 1c and 1d includes plural (here, three) head units 11. The head units 11 are arranged along a primary scanning direction, and are capable of being mounted to and demounted from a main body of the image forming apparatus. Each of the recording heads 1a, 1b, 1c and 1d may include only one head unit 11.

Further, the head unit 11 in the recording heads 1a, 1b, 1c and 1d includes recording elements arranged along a primary scanning direction. Each of the recording elements includes nozzles for ejecting ink, pressure chambers that are connected to the nozzles respectively and to which ink is supplied, and piezoelectricity actuators that are driven by a driving signal corresponding to image data of an image to be printed and pushes ink from the pressure chambers to the nozzles and thereby cause to eject ink from the nozzles. To each of the recording elements, a driving signal with a driving voltage is applied, and the driving voltage is set individually for each recording element group that contains plural recording elements. Therefore, in a certain recording element group, driving signals corresponding to recording elements are applied to the recording elements with same driving voltages for all the recording elements. This driving voltage is a voltage amplitude of the driving signal, and the driving voltage set to each recording element group is applied in accordance with a waveform of the driving signal by an unshown electric circuit.

The sheet transportation unit 10b transports the print sheet to the print engine 10a along a predetermined transportation path, and transports the print sheet after printing from the print engine 10a to a predetermined output destination (here, an output tray 10c or the like).

The sheet transportation unit 10b includes a main sheet transportation unit 10b1 and a circulation sheet transportation unit 10b2. In duplex printing, the main sheet transportation unit 10b1 transports to the print engine 10a a print sheet to be used for printing of a first-surface page image, and the circulation sheet transportation unit 10b2 transports the print sheet from a posterior stage of the print engine 10a to a prior stage of the print engine 10a with detaining a predetermined number of print sheets.

In this embodiment, the main sheet transportation unit 10b1 includes (a) a circular-type transportation belt 2 that is arranged so as to be opposite to the print engine 10a and transports a print sheet, (b) a driving roller 3 and a driven roller 4 around which the transportation belt 2 is hitched, (c) a nipping roller 5 that nips the print sheet with the transportation belt 2, and (d) output roller pairs 6 and 6a.

The driving roller 3 and the driven roller 4 rotate the transportation belt 2. The nipping roller 5 nips an incoming print sheet transported from a sheet feeding cassette 20-1 or 20-2 mentioned below, and the nipped print sheet is transported by the transportation belt 2 to printing positions of the inkjet recording units 1a to 1d in turn, and on the print sheet, images of respective colors are printed by the inkjet recording units 1a to 1d. Subsequently, after the color printing, the print sheet is outputted by the output roller pairs 6 and 6a to an output tray 10c or the like.

Further, the main sheet transportation unit 10b1 includes plural sheet feeding cassettes 20-1 and 20-2. The sheet feeding cassettes 20-1 and 20-2 store print sheets SH1 and SH2, and push up the print sheets SH1 and SH2 using lift plates 21 and 24 so as to cause the print sheets SH1 and SH2 to contact with pickup rollers 22 and 25, respectively. The print sheets SH1 and SH2 put on the sheet feeding cassettes 20-1 and 20-2 are picked up to sheet feeding rollers 23 and 26 by the pickup rollers 22 and 25 sheet by sheet from the upper sides, respectively. The sheet feeding rollers 23 and 26 are rollers that transport the print sheets SH1 and SH2 sheet by sheet fed by the pickup rollers 22 and 25 from the sheet feeding cassettes 20-1 and 20-2 onto a transportation path. A transportation roller 27 is a transportation roller on the transportation path common to the print sheets SH1 and SH2 transported from the sheet feeding cassettes 20-1 and 20-2.

When performing duplex printing, the circulation sheet transportation unit 10b2 returns the print sheet from a predetermined position in a downstream side of the print engine 10a to a predetermined position in an upstream side of the print engine 10a (here, to a predetermined position in an upstream side of a line sensor 31 mentioned below). The circulation sheet transportation unit 10b2 includes a transportation roller 41, and a switch back transportation path 41a that reverses a movement direction of the print sheet in order to change a surface that should face the print engine 10a among surfaces of the print sheet from the first surface to the second surface of the print sheet.

Further, the image forming apparatus 10 includes a line sensor 31 and a sheet detecting sensor 32.

The line sensor 31 is an optical sensor that is arranged along a direction perpendicular to a transportation direction of the print sheet, and detects positions of both end edges (both side edges) of the print sheet. For example, the line sensor 31 is a CIS (Contact Image Sensor). In this embodiment, the line sensor 31 is arranged at a position between the registration roller 28 and the print engine 10a.

The sheet detecting sensor 32 is an optical sensor that detects that a front end of the print sheet SH1 or SH2 passes through a predetermined position on the transportation path. The line sensor 31 detects the positions of the both side end edges at a time point that the front end of the print sheet SH1 or SH2 is detected by the sheet detecting sensor 32.

For example, as shown in FIG. 1, the print engine 10a is arranged in one of an upward part of the transportation path and a downward part of the transportation path (here, in the upward part); the line sensor 31 is arranged in the other of the upward part of the transportation path and the downward part of the transportation path (here, in the downward part); and the circulation transportation unit 10b2 transports the print sheet from the downstream side of the print engine 10a to the upstream side of the line sensor 31 with changing an orientation of the print sheet in a switch back manner.

In this embodiment, the line sensor 31 is installed to detect a position of a print sheet, and therefore, for example, after a test pattern mentioned below is printed on the print sheet, the circulation transportation unit 10b2 transports the print sheet and the line sensor 31 scans an image of the printed test pattern.

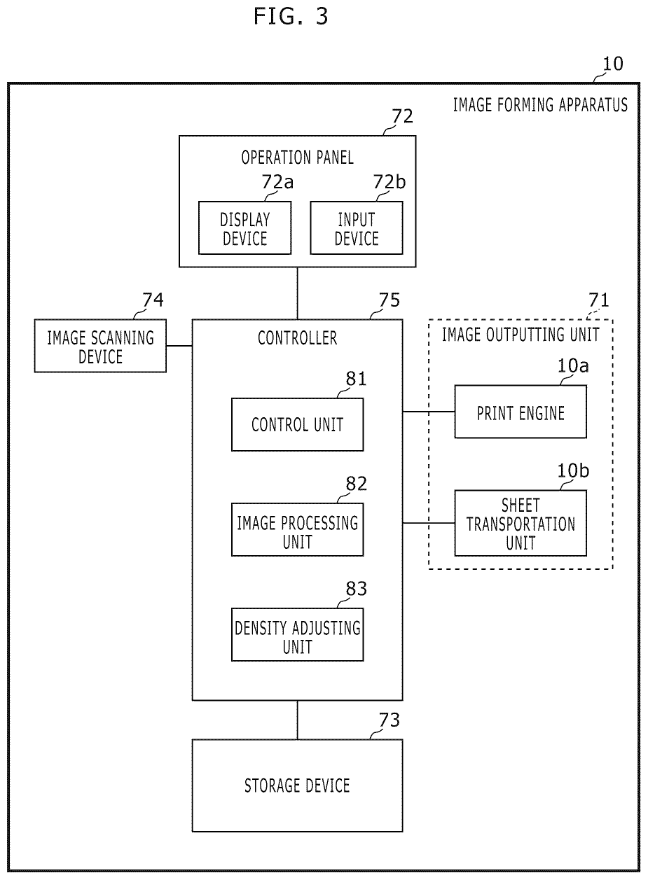

FIG. 3 shows a block diagram that indicates an electronic configuration of the image forming apparatus 10 in the embodiment according to the present disclosure. As shown in FIG. 3, the image forming apparatus 10 includes not only an image outputting unit 71 that includes the mechanical configuration shown in FIGS. 1 and 2 but an operation panel 72, a storage device 73, an image scanning device 74, and a controller 75.

The operation panel 72 is arranged on a housing surface of the image forming apparatus 10, and includes a display device 72a such as a liquid crystal display and an input device 72b such as a hard key and/or a touch panel, and displays sorts of messages for a user using the display device 72a and receives a user operation using the input device 72b.

The storage device 73 is a non-volatile storage device (flash memory, hard disk drive or the like) in which data, a program and the like have been stored that are required for control of the image forming apparatus 10. In the storage device 73, stored is data that indicates a driving voltage set to each recording element group in each of the head units 11.

The image scanning device 74 includes a platen glass and an auto document feeder, and optically scans a document image from a document put on the platen glass or a document fed by the auto document feeder, and generates image data of the document image.

The controller 75 includes a computer that performs a software process in accordance with a program, an ASIC (Application Specific Integrated Circuit) that performs a predetermined hardware process, and/or the like, and acts as sorts of processing units using the computer, the ASIC and/or the like. This computer includes a CPU (Central Processing Unit), a ROM (Read Only Memory), a RAM (Random Access Memory) and the like, and loads a program stored in the storage device 73, the ROM or the like to the RAM and executes the program using the CPU and thereby acts as processing units (with the ASIC if required). Here, the controller 75 acts as a control unit 81, an image processing unit 82, and a density adjusting unit 83.

The control unit 81 controls the image outputting unit 71 (the print engine 10a, the sheet transportation unit 10b and the like), and thereby performs a print job requested by a user. In this embodiment, the control unit 81 causes the image processing unit 82 to perform a predetermined image process, and controls the print engine 10a (the head units 11) and causes the head units 11 to eject ink and thereby forms a print image on a print sheet. Specifically, the control unit 81 supplies to each piezoelectricity actuator in the head unit 11 a driving signal with a driving voltage (voltage amplitude) set to each recording element group and thereby causes to eject ink from a nozzle. The image processing unit 82 performs a predetermined image process such as RIP (Raster Image Processing), color conversion, halftoning and/or the like for image data of a printing image.

As mentioned, the control unit 81 causes the print engine 10a to print a user document image based on printing image data specified by a user.

In this embodiment, the control unit 81 has an automatic centering function that (a) determines as an actual sheet center position a center position of a print sheet on the basis of the positions of both side end edges of the print sheet detected by the line sensor 31, and (b) adjusts a center position of an image to be printed, on the basis of a difference from the actual sheet center position, and performs the automatic centering function as a hardware process. Specifically, in the automatic centering function, the control unit 81 changes a depicting position of the image to be printed, in a primary scanning direction by a difference between a reference center position of the print engine 10a and the actual sheet center position. In this embodiment, because the nozzles of the recording heads 1a to 1d do not move, a nozzle corresponding to each pixel in the image to be printed is changed correspondingly to the depicting position of the image to be printed.

As mentioned, the control unit 81 determines nozzles corresponding to the image to be printed (a nozzle corresponding to each pixel), correspondingly to a position of a print sheet, and causes the recording heads 1a to 1d to eject ink from the determined nozzles.

The density adjusting unit 83 (a) causes each recording element group to eject ink for a first test chart with a first driving voltage and causes each recording element group to eject ink for a second test chart with a second driving voltage that is different from the first driving voltage, (b) acquires a density of the first test chart and a density of the second test chart, (c) derives a difference between the density of the first test chart and the density of the second test chart, and (d) derives a driving voltage corresponding to a target density on the basis of the difference between the density of the first test chart and the density of the second test chart and a difference between the first driving voltage and the second driving voltage.

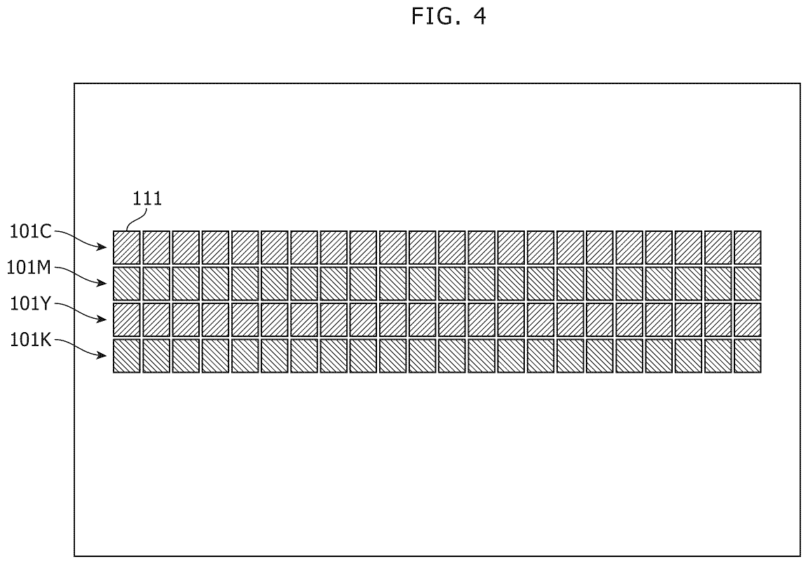

FIG. 4 shows a diagram that indicates an example of a test chart. As shown in FIG. 4, for example, test charts 101C, 101M, 101Y and 101K corresponding to ink colors are printed by the recording heads 1a to 1d, respectively. The test chart 101C is a test chart of Cyan, the test chart 101M is a test chart of Magenta, the test chart 101Y is a test chart of Yellow, and the test chart 101K is a test chart of Black. Each of the test charts 101C, 101M, 101Y and 101K includes patches 111 arranged along a primary scanning direction. It should be noted that each patch 111 is printed by a single recording element group in association with this patch. However, plural patches 111 may be printed by a single recording element group. Further, both of the aforementioned first and second test charts are printed on the basis of image data of a single test chart.

Furthermore, a density of each of the test charts 101C, 101M, 101Y and 101K (i.e. a density of the patch 111) is determined on the basis of image data obtained by optically scanning the test chart by the line sensor 31 or the image scanning device 74, for example. This density is an I.D. value, an RGB value, an L*a*b value, or the like. If plural patches 111 are printed by a single recording element group, an average of densities of these patches 111 is derived as a density of the test chart correspondingly to this recording element group.

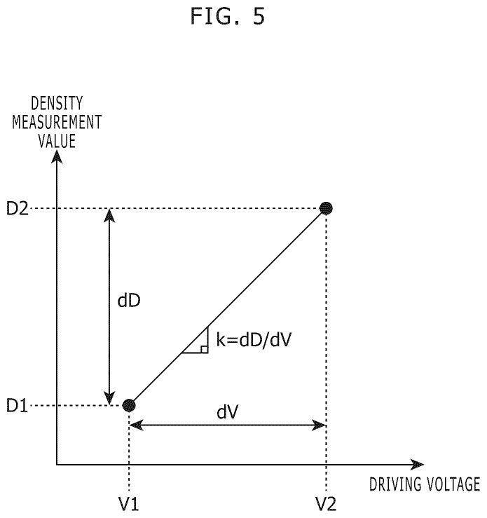

FIG. 5 shows a diagram that explains a relationship between a changing amount of a driving voltage and a changing amount of a density. As shown in FIG. 5, for example, when a driving voltage of a recording element group is increased, a density of a printed image also increases. However, since ink smudge and color properties are different between types of print sheets, a changing amount of the density to a changing amount of the driving voltage changes due to types of print sheets.

Therefore, one of the first test chart and the second test chart is set as a reference test chart, and the density adjusting unit (a) derives a difference between the target density and a density of the reference test chart, (b) derives a correction amount of the driving voltage from the difference between the target density and a density of the reference test chart, the difference between the density of the first test chart and the density of the second test chart, and the difference between the first driving voltage and the second driving voltage, and (c) derives a driving voltage corresponding to the target density from the correction amount, and the first or second driving voltage corresponding to the reference test chart, and renews the aforementioned data of the driving voltage with the derived driving voltage. After the renewal, when printing, a driving signal with the driving voltage is applied to the recording element group.

Specifically, as shown in FIG. 5, for example, the density adjusting unit 83 (a) derives as a correction coefficient K a ratio (dD/dV) between the difference dD between the density D1 of the first test chart and the density D2 of the second test chart and the difference dV between the first driving voltage V1 and the second driving voltage V2, and (b) multiplies or divides the difference between the target density and the density (D1 or D2) of the reference test chart by the correction coefficient k and thereby derives the aforementioned correction amount. Here, if the aforementioned ratio is dD/dV, the dividing is performed and otherwise if the aforementioned ratio is dV/dD, the multiplying is performed.

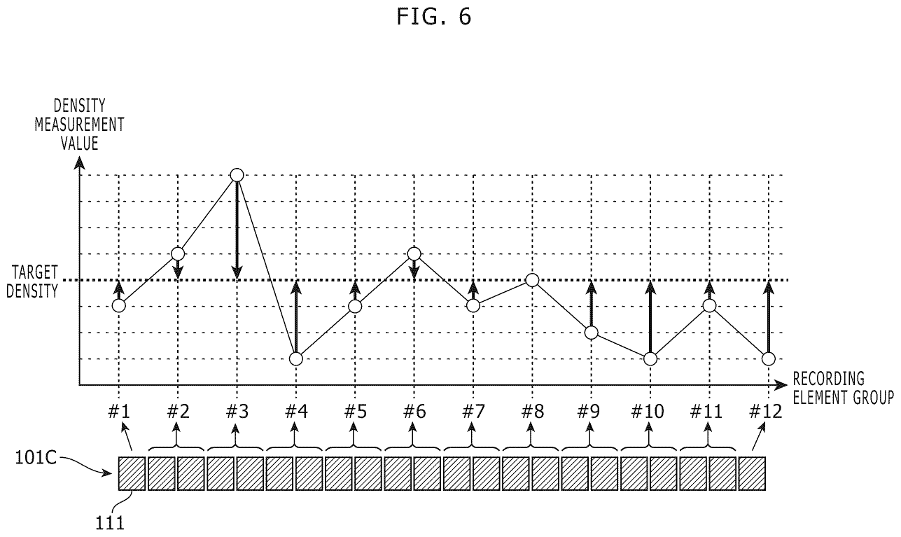

FIG. 6 shows a diagram that explains restrainment of density unevenness by plural recording element groups. As shown in FIG. 6, for example, regarding each of the recording element groups #1 to #12, the density adjusting unit 83 adjusts the driving voltage and thereby adjusts an ink ejection amount of the recording element group and makes a density of an image depicted by the recording element group close to the target density (e.g. a target density for a maximum density of a solid image), and consequently, density fluctuation by plural recording element groups is restrained. Here, each recording element group #i corresponds to one or two patches 111.

After deriving the driving voltage corresponding to the target density as mentioned, the density adjusting unit 83 (a) causes the recording element group to eject ink for a third test chart with the derived driving voltage, (b) acquires a density of the third test chart, and (c) determines whether an error between the density of the third test chart and the target density is less than a predetermined threshold value or not. If the error between the density of the third test chart and the target density is not less than the predetermined threshold value, the density adjusting unit 83 derives a correction coefficient on the basis of the density of the first test chart, the density of the second test chart, the density of the third test chart, the first driving voltage, the second driving voltage, and the derived driving voltage, and derives an additional correction amount from the correction coefficient and the aforementioned error, and corrects the driving voltage corresponding to the target density with the additional correction amount.

For example, the correction coefficient is derived using a least squares method on the basis of the density of the first test chart, the density of the second test chart, the density of the third test chart, the first driving voltage, the second driving voltage, and the derived driving voltage.

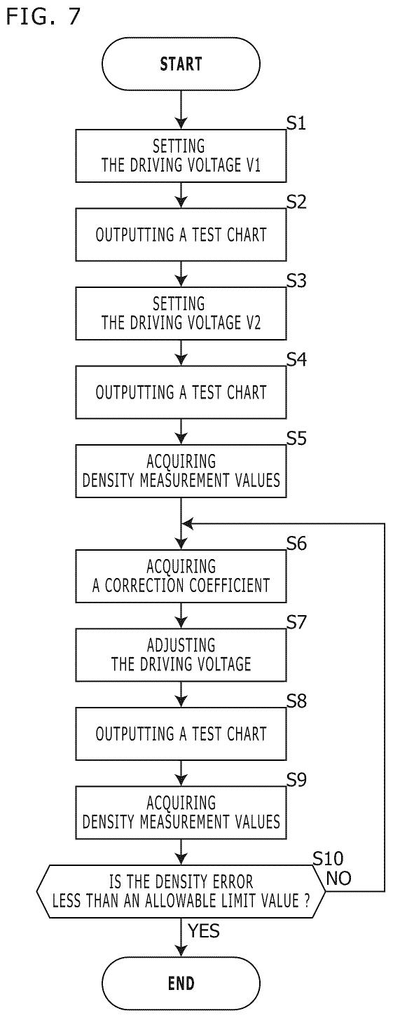

The following part explains a behavior of the aforementioned image forming apparatus 1. FIG. 7 shows a flowchart that explains a behavior of the image forming apparatus shown in FIGS. 1 to 3.

The density adjusting unit 83 sets the driving voltage of each recording element group as a driving voltage V1 (in Step S1), and supplies a driving signal with the driving voltage V1 to each recording element group and thereby causes each recording element group to eject ink, and prints test charts 101C, 101M, 101Y and 101K on a print sheet of a predetermined type (in Step S2).

Subsequently, the density adjusting unit 83 sets the driving voltage of each recording element group as a driving voltage V2 (in Step S3), and supplies a driving signal with the driving voltage V2 to each recording element group and thereby causes each recording element group to eject ink, and prints test charts 101C, 101M, 101Y and 101K on a print sheet of a type same as the predetermined type (in Step S4).

Consequently, two test charts (of each ink color) corresponding to the driving voltages V1 and V2 are acquired. The two test charts may be printed on a single print sheet.

The density adjusting unit 83 acquires density measurement values D1 and D2 of the two test charts (in Step S5), and derives a correction coefficient k from the driving voltages V1 and V2 and the density measurement values D1 and D2 (in Step S6), and adjusts the driving voltage on the basis of the correction coefficient k to make the density of the test chart close to the target density (in Step S7).

Subsequently, the density adjusting unit 83 sets a driving voltage V3 obtained by the adjustment, and supplies a driving signal with the driving voltage V3 to each recording element group and thereby causes each recording element group to eject ink, and prints test charts 101C, 101M, 101Y and 101K in the same manner (in Step S8).

Consequently, a test chart (of each ink color) corresponding to the driving voltage V3 is acquired.

The density adjusting unit 83 acquires a density measurement value D3 of this test chart (in Step S9), and determines whether a density error (difference between the density measurement value D3 and the target density) is less than a predetermined threshold value or not (in Step S10).

If the density error is less than the predetermined threshold value, the adjustment of the driving voltage is terminated. The aforementioned adjustment of the driving voltage is performed individually for each ink color and for each recording element group.

Contrarily, if the density error is not less than the predetermined threshold value, then returning to Step S6, the density adjusting unit 83 newly derives a correction coefficient k from the driving voltages V1 to V3 and the density measurement values D1 to D3 using a least squares method or the like (in Step S6), adjusts the driving voltage on the basis of this correction coefficient k to make a density of the test chart close to the target density (in Step S7), and sets the driving voltage Vi (i=4, 5, . . . ) obtained by the adjustment and prints test charts 101C, 101M, 101Y and 101K (in Step S8), acquires a density Di of each of the test charts 101C, 101M, 101Y and 101K (in Step S9), and determines whether a density error (difference between the density measurement value Di and the target density, here) is less than a predetermined threshold value or not (in Step S10). The density error may be a difference between a highest density and a lowest density among densities of test charts corresponding to all recording element groups for each ink color.

As mentioned, repeatedly until the density error gets less than the predetermined threshold value, the test chart is additionally printed and the correction coefficient k is derived on the basis of the driving voltages V1 to Vi and the density measurement values D1 to Di, and the driving voltage is additionally adjusted on the basis of the correction coefficient.

As mentioned, in the aforementioned embodiment, the density adjusting unit 83 (a) causes each recording element group of the recording heads 1a to 1d to eject ink for a first test chart with a first driving voltage and causes each recording element group of the recording heads 1a to 1d to eject ink for a second test chart with a second driving voltage that is different from the first driving voltage, (b) acquires a density of the first test chart and a density of the second test chart, (c) derives a difference between the density of the first test chart and the density of the second test chart, and (d) derives a driving voltage corresponding to a target density on the basis of the difference between the density of the first test chart and the density of the second test chart and a difference between the first driving voltage and the second driving voltage.

Consequently, a changing amount of a printing density corresponding to a changing amount of the driving voltage is determined for each print sheet type, and therefore, regardless of a characteristic of a print sheet (strength of ink smudge, color properties and the like), the proper driving voltage is acquired correspondingly to a print sheet.

It should be understood that various changes and modifications to the embodiments described herein will be apparent to those skilled in the art. Such changes and modifications may be made without departing from the spirit and scope of the present subject matter and without diminishing its intended advantages. It is therefore intended that such changes and modifications be covered by the appended claims.

For example, in the aforementioned embodiment, in Steps S1 to S7, the driving voltage corresponding to the target density is derived from two test charts (the first and second test charts), and alternatively, the aforementioned correction coefficient may be derived from three or more test charts printed with driving voltages different from each other using a least squares method or the like.

Further, in the aforementioned embodiment, among the first and second test charts, one of which a density error from the target density is smaller than that of the other may be selected as the reference test chart.

Furthermore, in the aforementioned embodiment, a colorimeter may be used to acquire measure values of densities of the test charts and the measurement values may be inputted to the density adjusting unit 83 instead of the measurement of densities of the test charts using the line sensor 31 or the image scanning device 74.

Furthermore, in the aforementioned embodiment, data of the driving voltages in association with print sheet types may have been stored in the storage device 73, and the controller 75 may determine a print sheet type of a print sheet to be used for printing, reads a driving voltage for the determined print sheet type from the storage device 73, and may apply the driving voltage to the recording element groups and perform printing of a user image (an image specified by a user).

What is claimed is:

1. An image forming apparatus, comprising:
a recording element group configured to eject ink correspondingly to a driving voltage; and
a density adjusting unit configured to (a) cause to eject ink for a first test chart with a first driving voltage and causes to eject ink for a second test chart with a second driving voltage that is different from the first driving voltage, (b) acquire a density of the first test chart and a density of the second test chart, (c) derive a difference between the density of the first test chart and the density of the second test chart, and (d) derive a driving voltage corresponding to a target density on the basis of the difference between the density of the first test chart and the density of the second test chart and a difference between the first driving voltage and the second driving voltage.

2. The image forming apparatus according to claim 1, wherein one of the first test chart and the second test chart is set as a reference test chart; and the density adjusting unit (a) derives a difference between the target density and a density of the reference test chart, (b) derives a correction amount of the driving voltage from the difference between the target density and a density of the reference test chart, the difference between the density of the first test chart and the density of the second test chart, and the difference between the first driving voltage and the second driving voltage, and (c) derives a driving voltage corresponding to the target density from the correction amount, and the first or second driving voltage corresponding to the reference test chart.

3. The image forming apparatus according to claim 2, wherein the density adjusting unit (a) derives as a correction coefficient a ratio between the difference between the density of the first test chart and the density of the second test chart and the difference between the first driving voltage and the second driving voltage, and (b) multiplies or divides the difference between the target density and the density of the reference test chart by the correction coefficient and thereby derives the correction amount.

4. The image forming apparatus according to claim 1, wherein the density adjusting unit (a) causes the recording element group to eject ink for a third test chart with the derived driving voltage, (b) acquires a density of the third test chart, (c) if an error between the density of the third test chart and the target density is not less than a predetermined threshold value, derives a correction coefficient on the basis of the density of the first test chart, the density of the second test chart, the density of the third test chart, the first driving voltage, the second driving voltage, and the derived driving voltage, (d) derives an additional correction amount from the correction coefficient and the error, and (e) corrects the driving voltage corresponding to the target density with the additional correction amount.
